(19) United States
(12) Patent Application Publication
(10) Pub. No.: US 2016/0218371 A1
(43) Pub. Date: Jul. 28, 2016

(54) FUEL CELL ELECTRODE CATALYST LAYER HAVING ELECTRON CONDUCTING POLYMERS

(71) Applicant: Nissan North America, Inc., Franklin, TN (US)

(72) Inventor: Ellazar Niangar, Redford, MI (US)

(21) Appl. No.: 14/607,150

(22) Filed: Jan. 28, 2015

(51) Int. Cl. H01M 4/92; H01M 4/90; H01M 4/86

(52) U.S. Cl. CPC H01M 4/925; H01M 4/8668; H01M 4/8673; H01M 4/9075

(57) ABSTRACT

A catalyst layer for a fuel cell electrode includes catalyst particles consisting essentially of metal oxide support particles with active catalyst particles supported on the metal oxide support particles. The catalyst particles are intermixed with an electron-conducting polymer. The metal oxide particles have low electron conductivity.

### TECHNICAL FIELD

This disclosure relates to a catalyst layer for a fuel cell having non-carbon catalyst particles using a low electron conducting metal oxide support mixed with an electron-conducting polymer.

### BACKGROUND

Carbon has traditionally been the most common material of choice for polymer electrolyte fuel cell (PEFC) electrocatalyst supports due to its low cost, high abundance, high electronic conductivity, and high Brunauer, Emmett, and Teller (BET) surface area, which permits good dispersion of platinum (Pt) active catalyst particles. However, the instability of the carbon-supported platinum electrocatalyst due at least in part to carbon corrosion is a key issue that currently precludes widespread commercialization of PEFCs for automotive applications.

The adverse consequences of carbon corrosion include (i) platinum nanoparticle agglomeration/detachment; (ii) macroscopic electrode thinning/loss of porosity in the electrode; and (iii) enhanced hydrophilicity of the remaining support surface. The first results in loss of catalyst active surface area and lower mass activity resulting from reduced platinum utilization, whereas the second and third result in a lower capacity to hold water and enhanced flooding, leading to severe condensed-phase mass transport limitations. Clearly, both consequences directly impact PEFC cost and performance, especially in the context of automotive stacks.

To address the issues with carbon-based catalyst, non-carbon alternatives are being investigated, such as metal oxides. However, some metal oxides alternatives are cost-prohibitive, and corrosion of the metal oxide alternatives can still occur.

### SUMMARY

A catalyst layer for a fuel cell electrode is disclosed comprising catalyst particles consisting essentially of metal oxide support particles with active catalyst particles supported on the metal oxide support particles. The catalyst particles are intermixed with an electron-conducting polymer. The metal oxide particles have low electron conductivity.

Also disclosed are fuel cells having the catalyst layers disclosed herein. One embodiment of a fuel cell electrode has an active material layer comprising catalyst consisting essentially of support particles of a low electron conducting metal oxide and active catalyst particles supported on the support particles. The active material layer also comprises a proton-conducting polymer and an electron-conducting polymer. The catalyst is intermixed with proton-conducting polymer and the electron-conducting polymer prior to depositing on one of a membrane or a gas diffusion layer.

These and other aspects of the present disclosure are disclosed in the following detailed description of the embodiments, the appended claims and the accompanying figures.

### BRIEF DESCRIPTION OF THE DRAWINGS

The various features, advantages and other uses of the present apparatus will become more apparent by referring to the following detailed description and drawing in which:

FIG. 1 is a schematic illustrating an embodiment of the catalyst layer having electron conducting polymers as disclosed herein; and

FIG. 2 is a schematic of a fuel cell using the catalyst layer having electron conducting polymers as disclosed herein.

### DETAILED DESCRIPTION

One example of a non-carbon metal oxide catalyst support consists essentially of a non-conductive metal oxide such as titanium dioxide. Titanium dioxide (TiO₂) has very good chemical stability in acidic and oxidative environments. However, titanium dioxide is a semiconductor and its electron conductivity is very low.

To overcome the deficiencies of the non-conductive metal oxide alone, a non-carbon metal oxide support having both a non-conductive oxide and a conductive oxide have been developed. For example, a non-carbon mixed-metal oxide support of TiO₂ and conductive metal oxides such as oxides of ruthenium have been developed. A precious metal active catalyst particle such as platinum is deposited on the TiO₂—RuO₂ support. Although ruthenium is highly electron conductive, ruthenium is costly. Furthermore, the ruthenium particles can migrate across the membrane, resulting in agglomeration and reduction of electron conductivity in either or both of the anode or the cathode.

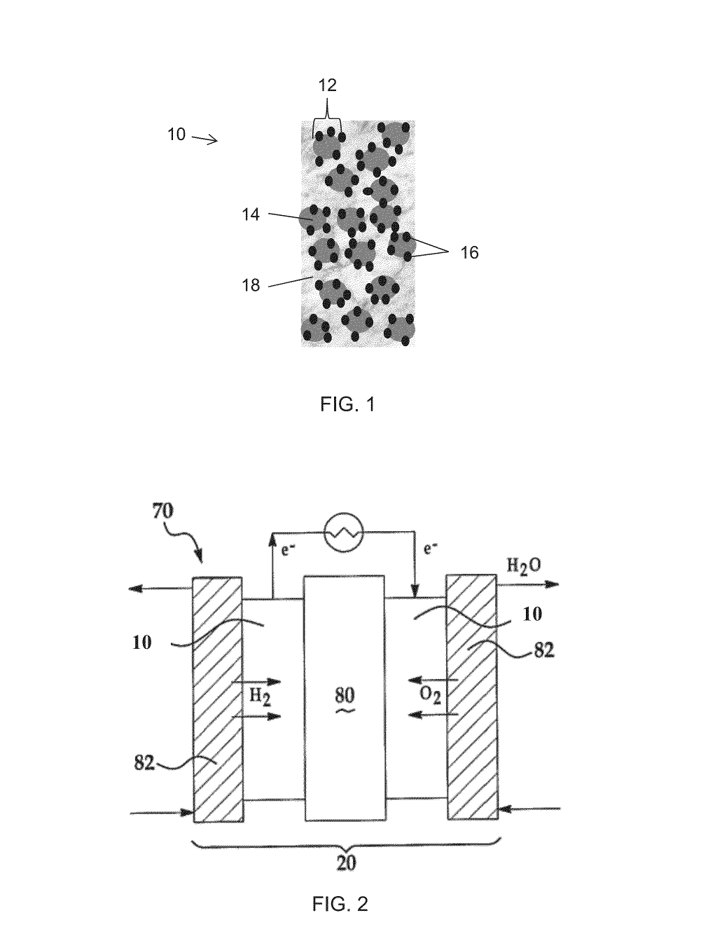

Disclosed herein are embodiments of a catalyst layer for a fuel cell electrode that has the requisite electron conductivity without the use of high electron conductive metal oxides. FIG. 1 is a schematic of a catalyst layer 10 of a fuel cell, the catalyst layer 10 configured to be positioned between a fuel cell membrane and a gas diffusion layer. The catalyst layer 10 comprises catalyst particles 12 consisting essentially of metal oxide support particles 14 with active catalyst particles 16 supported on the metal oxide support particles 14. The catalyst particles 12 are intermixed with an electron-conducting polymer 18.

The metal oxide support particles 14 have low electron conductivity. As used herein, “low electron conductivity” refers to those metal oxides having insufficient electron conductivity to be used solely as the electron conductor in fuel cell catalyst and include metal oxides that do not conduct electrons. The metal oxide support particles 14 can be one or more metal oxides prepared with varying ratios of metal oxides and various particle sizes depending on the metal oxides used. The metal oxide support particles 14 can be nanotubes or core shells. The metal oxide support particles 14 can be one or more of titanium dioxide and Magnéli phase Ti₄O₇. A modified non-conductive metal oxide material can also or alternatively be used as the metal oxide support particle 14. The modified metal oxide is obtained by doping the metal oxide with a dopant such as indium, niobium and tantalum. One or more dopants can be used. Examples of modified metal oxide support particles 14 also include indium-doped tin oxide and tin-doped indium oxide.

The active catalyst particles 16 can include one or a combination of precious metals such as platinum, gold, rhodium, ruthenium, palladium and iridium, and/or transition metals such as cobalt and nickel. The precious metal can be in various forms, such as alloys, nanowires, nanoparticles and coreshells, which are bimetallic catalysts that possess a base metal core surrounded by a precious metal shell.

The electron-conducting polymer 18 is intermixed with the catalyst particles 12 and provides the requisite electron conductivity for the catalyst layer 10. The electron-conducting polymer 18 can also act as a binder, replacing conventional binder materials in catalyst layer 10. The electron-conducting polymer 18 also eliminates cross-over of costly high electron conductive metal oxides and reduces agglomeration. A proton-conducting polymer, such as Nafion™, can also be intermixed with the electron-conducting polymer 18 and the catalyst particles 12. The electron-conducting polymer 18 can be an electron-conducting plastic. Non-limiting examples of electron-conducting polymers 18 include poly(p-phenylene vinylene), polyaniline, polypyrrole, polythiophene, and polyacetylene.

FIG. 2 illustrates the use of the catalyst layer 10 disclosed herein in a fuel cell electrode. FIG. 2 is a schematic of a fuel cell 70, a plurality of which makes a fuel cell stack. The fuel cell 70 is comprised of a single membrane electrode assembly 20. The membrane electrode assembly 20 has a membrane 80 coated with the catalyst layer 10 with a gas diffusion layer 82 on opposing sides of the membrane 80. The membrane 80 has catalyst layers 10 formed on opposing surfaces of the membrane 80, such that when assembled, the catalyst layers 10 are each between the membrane 80 and a gas diffusion layer 82. Alternatively, a gas diffusion electrode is made by forming one catalyst layer 10 on a surface of two gas diffusion layers 82 and sandwiching the membrane 80 between the gas diffusion layers 82 such that the catalyst layers 10 contact the membrane 80. When fuel, such as hydrogen gas (shown as H₂), is introduced into the fuel cell 70, the catalyst layer 10 splits hydrogen gas molecules into protons and electrons. The protons pass through the membrane 80 to react with the oxidant (shown as O₂), such as oxygen or air, forming water (H₂O). The electrons (e⁻), which cannot pass through the membrane 80, must travel around it, thus creating the source of electrical energy.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A catalyst layer for a fuel cell electrode comprising catalyst particles consisting essentially of metal oxide support particles with active catalyst particles supported on the metal oxide support particles, the catalyst particles intermixed with an electron-conducting polymer, wherein the metal oxide particles have low electron conductivity.

2. The catalyst layer of claim 1, wherein the metal oxide support particles are titanium dioxide particles.

3. The catalyst layer of claim 1, wherein the metal oxide support particles are one of indium-doped tin oxide and tin-doped indium oxide.

4. (canceled)

5. The catalyst layer of claim 1, wherein the active catalyst particles are platinum.

6. The catalyst layer of claim 1, wherein the electron-conducting polymer is an electron-conducting plastic.

7. The catalyst layer of claim 1, wherein the electron-conducting polymer is a poly(p-phenylene vinylene).

8. The catalyst layer of claim 1, wherein the electron-conducting polymer is selected from one of polyaniline, polypyrrole, polythiophene, and polyacetylene.

9. The catalyst layer of claim 1, further comprising a proton-conducting polymer.

10. The catalyst layer of claim 1, wherein the electron-conducting polymer is also used as a binder.

11. A fuel cell electrode having an active material layer comprising:
catalyst consisting essentially of:
support particles of a low electron conducting metal oxide; and
active catalyst particles supported on the support particles;
a proton-conducting polymer; and
an electron-conducting polymer, wherein the catalyst is intermixed with proton-conducting polymer and the electron-conducting polymer prior to depositing on one of a membrane or a gas diffusion layer.

12. The fuel cell electrode of claim 11, wherein the low electron conducting metal oxide is titanium dioxide.

13. The fuel cell electrode of claim 11, wherein the low electron conducting metal oxide is one of indium-doped tin oxide and tin-doped indium oxide.

14. (canceled)

15. The fuel cell electrode of claim 11, wherein the active catalyst particles are platinum.

16. The fuel cell electrode of claim 11, wherein the electron-conducting polymer is an electron-conducting plastic.

17. The fuel cell electrode of claim 11, wherein the electron-conducting polymer is a poly(p-phenylene vinylene).

18. The fuel cell electrode of claim 11, wherein the electron-conducting polymer is selected from one of polyaniline, polypyrrole, polythiophene, and polyacetylene.
